(19) United States
(12) Patent Application Publication
(10) Pub. No.: US 2026/0047628 A1
(43) Pub. Date: Feb. 19, 2026

(54) Thermal Insulation Material Capable of Absorbing Solar Energy and Releasing Heat

(71) Applicant: Zhenkun Zack Wang, Cambridge, MA (US)

(72) Inventor: Zhenkun Zack Wang, Cambridge, MA (US)

(21) Appl. No.: 19/304,537

(22) Filed: Aug. 19, 2025

(30) Foreign Application Priority Data
Aug. 19, 2024 (CN) 2024220195872

(51) Int. Cl. A41D 31/06; A47G 9/00; A47G 9/02; B32B 3/10; B32B 3/26; B32B 7/027; B32B 27/12; F16L 59/07; F24S 20/55; F24S 60/00

(52) U.S. Cl. CPC A41D 31/065; A47G 9/0215; A47G 9/0223; B32B 3/10; B32B 3/266; B32B 7/027; B32B 27/12; F16L 59/07; F24S 20/55; F24S 60/00; A47G 2009/003; B32B 2307/304; B32B 2437/00

(57) ABSTRACT

The present invention relates to the fields of clothing and thermal insulation, specifically to a thermal insulation material capable of absorbing solar energy and releasing heat. The present invention can be used as a material for manufacturing thermal insulation products such as clothing, blankets, quilts, etc., and serves the function of temperature regulation.

### TECHNICAL BACKGROUND

Since ancient times, human thermal insulation methods, ranging from animal hides in antiquity to modern down jackets, have relied on the inherent thermal insulation properties of the clothing materials themselves to maintain human body temperature. In contrast, our novel thermal insulation clothing does not rely entirely on the inherent properties of the material itself but utilizes solar energy, absorbing solar energy and storing its thermal energy. After storage, when the human body requires warmth, the stored thermal energy is released to provide heat to the body. The present invention stores solar energy during the daytime when sunlight is available; at night when temperatures are lower, or at other times when warmth is required, the clothing can release the stored thermal energy to provide heat to the human body, or function as a heat-releasing bedding covering the body, providing warmth by releasing thermal energy to the human body. In desert regions with large diurnal temperature variations, the material is worn with the heat absorption side outwards during the sunny day and reversed for heat release when the sun is absent; blankets can likewise be sunned outdoors during the day and used for covering at night. Compared to traditional thermal insulation clothing methods, it provides superior warmth and can supply the required temperature to the human body in various harsh environments.

### SUMMARY OF THE INVENTION

The objective of the present invention is to provide a thermal insulation material capable of absorbing solar energy and releasing heat. The present invention is a material capable of absorbing solar radiant heat; it absorbs the thermal energy of solar radiation during the daytime and slowly releases heat at low temperatures during the night. It can be used for making clothing, blankets, etc.

The specific structure of the present invention comprises three layers. The first layer comprises gas-filled bladders filled with a safe and stable substance having a relatively high specific heat capacity. Substances with a relatively high specific heat capacity possess the characteristic of strong heat absorption capacity and slow heat release, such as hydrogen, helium, or other materials.

The second layer, when serving as a thermal insulation material, is a soft and comfortable material possessing certain thermal insulation properties. After the absorption layer absorbs heat, the second layer functions as an isolation layer to prevent the heat absorbed by the bladders during the daytime from exchanging with the external environment or the body, thereby protecting the absorbed heat.

The third layer is a thermal insulation layer made of a silver-colored material fabricated from high-temperature protective materials such as polyphenylene sulfide (PPS) fiber, for example, the material used in clothing for workers near furnaces. It functions to protect the absorbed thermal energy and can prevent heat exchange between the external temperature and the internal temperature, thereby avoiding unnecessary heat exchange and reducing thermal energy loss. Furthermore, when the heat absorbed during the daytime is excessive and intolerable to the human body, this layer protects the human body by insulating against the heat.

The method of using this material is as follows:

When the material is fabricated into clothing, it is worn during the daytime with the bladder side facing outwards to absorb heat; regardless of the user's location, it absorbs heat whenever exposed to sunlight; when heat release is required at night, the garment is reversed and worn with the bladder side facing inwards against the body, whereupon the bladders automatically release heat to supply warmth to the human body.

When this material is used as a blanket, during the daytime, the bladder side is faced outwards and placed in any sunny location for exposure; when sunlight is absent, it is stored; when heat is required, the bladder side is faced inwards and placed over the body or spread on a bed to achieve heat release and supply warmth.

To achieve the above objective, the present invention provides the following technical solution:

The present invention is a multi-purpose energy-saving material capable of absorbing solar energy and releasing heat. During the daytime when sunlight is present, the absorption layer fully absorbs solar energy and stores all the thermal energy within the absorption layer under the protection of the thermal insulation layer. When temperatures decrease at night and heat release is required, reversing the material enables slow heat release, and with the thermal insulation layer positioned externally, it protects the absorbed thermal energy from exchanging heat with the external environment, reducing energy loss and enabling full utilization of the absorbed energy.

When used as a clothing material, the outermost layer of the garment is the heat absorption layer. The heat absorption layer comprises gas-filled bladders capable of fully absorbing and storing thermal energy. The middle layer is a soft and comfortable isolation layer. The third layer is a thermal insulation layer having the effect of protecting the stored thermal energy (specific materials may include multi-layer aluminized polyester film, etc.).

During the daytime, it fully absorbs and stores thermal energy. At night when heat release is required, reversing the garment enables heat release, and since the outermost layer is the thermal insulation layer, it prevents the internal thermal energy from exchanging heat with the external environment, enabling prolonged heat release.

Furthermore, ventilation perforations are provided in the interstices of the heat absorption layer. The number and size of the perforations vary according to the intended use, enabling breathability and comfort during use. Since the garment filler is a gas or liquid, it also provides a protective function for the human body in the event of accidental falls.

### BRIEF DESCRIPTION OF THE DRAWINGS

FIG. 1: External View

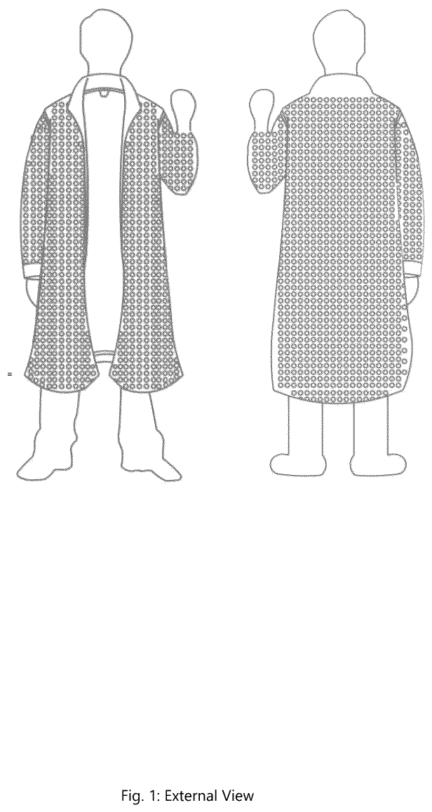

Both the front and back consist of circular bladders distributed across all areas of the garment.

FIG. 2: Solar Energy Absorption Material Diagram

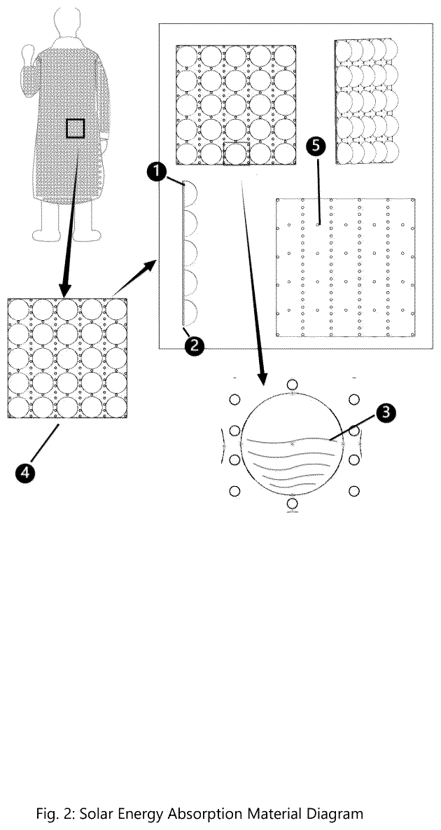

Ventilation perforations penetrate between each bladder, and the bladders are filled with gas having a high specific heat capacity.

FIG. 3: Daytime Heat Absorption Diagram

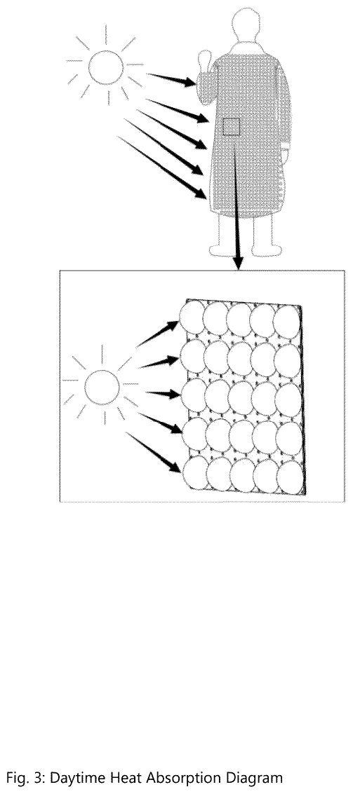

During the daytime, the exposed bladders fully absorb thermal energy and store it within the bladders.

FIG. 4: Nighttime Heat Release Diagram

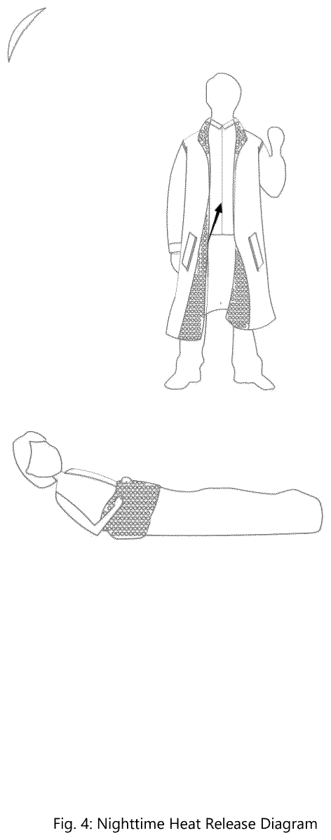

At night, the garment is reversed and worn, releasing the thermal energy stored during the daytime to provide warmth to the human body, and can also function as a quilt.

### Thermal Insulation Layer

\textcircled{2} Isolation Layer
\textcircled{3} Gas with High Specific Heat Capacity
\textcircled{4} Bladder Layer
\textcircled{5} Ventilation Perforations

### DETAILED DESCRIPTION OF EMBODIMENTS

When used as a clothing material, one side of the garment is entirely composed of this material. During the daytime, the bladders face outwards to absorb heat. When heat release is required at night, the garment is reversed and worn with the bladder side facing inwards against the body, whereupon the bladders automatically release heat to supply warmth to the human body.

The material comprises three layers: the first layer is the \textcircled{4} Bladder Layer, the second layer is the \textcircled{2} Isolation Layer, and the third layer is the \textcircled{3} Thermal Insulation Layer.

Each bladder is filled with a safe and stable gaseous filler having a relatively high specific heat capacity, and numerous \textcircled{5} Ventilation Perforations exist between each bladder.

During the daytime, the \textcircled{4} Bladder Layer faces outwards to absorb heat, the \textcircled{2} Isolation Layer protects the human body, and the \textcircled{3} Thermal Insulation Layer prevents heat exchange loss from the bladders.

At night, the \textcircled{4} Bladder Layer faces inwards, slowly releasing heat towards the human body.

The following embodiments will further describe the thermal insulation material capable of absorbing solar energy and releasing heat according to the present invention in detail with reference to the drawings. It is apparent that the described embodiments are only part of the embodiments of the present invention, and not all embodiments. Based on the embodiments in the present invention, all other embodiments obtained by persons of ordinary skill in the art without making creative efforts shall fall within the protection scope of the present invention.

1. A thermal insulation material capable of absorbing solar energy and releasing heat, comprising a three-layer structure, wherein:
a first layer comprises gas-filled bladders filled with a safe and stable substance having a relatively high specific heat capacity, the substance being selected from hydrogen, helium, or other materials, such substances possessing the characteristic of strong heat absorption capacity and slow heat release;
a second layer comprises a soft and comfortable material having the effect of protecting the absorbed thermal energy from exchange when serving as a thermal insulation material; and
a third layer comprises a thermal insulation layer having the effect of protecting the absorbed thermal energy and preventing heat exchange between an external temperature and an internal temperature, thereby avoiding unnecessary heat exchange, reducing thermal energy loss, and protecting a human body from excessive absorbed heat that may be intolerable.

2. A method of utilizing a multi-purpose energy-saving thermal insulation material capable of absorbing solar energy and releasing heat, comprising:
during daytime when sunlight is present, positioning an absorption layer comprising gas-filled bladders so as to fully absorb solar energy and store thermal energy within the absorption layer under protection of a thermal insulation layer; and
when temperatures decrease at night and heat release is required, reversing the material so that the thermal insulation layer is positioned externally, thereby enabling slow release of heat from the bladders, protecting the absorbed thermal energy from exchanging heat with the external environment, reducing energy loss, and enabling full utilization of the absorbed energy.

3. A garment or blanket fabricated from the thermal insulation material of claim 1, wherein:
the outermost layer is a heat absorption layer comprising gas-filled bladders capable of fully absorbing and storing thermal energy,
the middle layer is a soft and comfortable isolation layer, and
the innermost layer is a thermal insulation layer having the effect of protecting the stored thermal energy,
ventilation perforations are provided in interstices between the bladders of the heat absorption layer, the number and size of the perforations varying according to intended use to enable breathability and comfort,
the gas within the bladders provides a protective cushioning function for the human body in the event of accidental falls,
when fabricated as clothing, the garment is worn during daytime with the bladder side facing outward to absorb heat and at night reversed with the bladder side facing inward to release heat to the human body, and
when fabricated as a blanket, the bladder side is faced outward and exposed to sunlight during the day to store thermal energy, and at night the bladder side is faced inward toward the body to release heat and supply warmth.

4. The thermal insulation material of claim 1, wherein the safe and stable substance filling the gas-filled bladders is helium.

5. The thermal insulation material of claim 1, wherein the safe and stable substance filling the gas-filled bladders is hydrogen.

6. The thermal insulation material of claim 1, wherein the safe and stable substance filling the gas-filled bladders is an inert gas.

7. The thermal insulation material of claim 1, wherein the second layer comprises cotton, wool, synthetic fiber, or combinations thereof.

8. The thermal insulation material of claim 1, wherein the third layer comprises a polymeric thermal insulation film or a multi-layer reflective barrier.

9. The thermal insulation material of claim 1, wherein the gas-filled bladders are formed as interconnected cells configured to evenly distribute absorbed thermal energy.

10. The method of claim 2, further comprising regulating the rate of heat release by varying a thickness of the thermal insulation layer.

11. The method of claim 2, wherein the material is oriented with the bladder side facing a solar radiation source for at least two hours to maximize stored energy.

12. The garment of claim 3, wherein the ventilation perforations are circular and have a diameter between 0.5 millimeters and 5 millimeters.

13. The garment of claim 3, wherein the ventilation perforations are arranged in a grid pattern to optimize breathability.

14. The garment of claim 3, wherein the garment further comprises a fastening mechanism selected from zippers, buttons, or hook-and-loop fasteners to facilitate reversible wearing.

15. The blanket of claim 3, wherein the blanket further comprises an outer protective fabric layer resistant to ultraviolet degradation.
